(19) United States
(12) Patent Application Publication
(10) Pub. No.: US 2009/0323784 A1
(43) Pub. Date: Dec. 31, 2009

(54) Software-Defined Radio Platform Based Upon Graphics Processing Unit

(75) Inventors: Francois Depienne, Olm (LU); Fan Yang, Beijing (CN); Yuankai Ge, Beijing (CN); Yongguang Zhang, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/147,480

(22) Filed: Jun. 27, 2008

(51) Int. Cl. H04B 1/38

(52) U.S. Cl. 375/219

(57) ABSTRACT

Described is using a graphic processing unit (GPU) as a programming platform to implement radio communication technologies. A software defined radio platform is implemented via a graphics processing unit (GPU). The GPU includes modules, corresponding to kernels, that process an incoming bitstream (e.g., from a CPU) into baseband signals for output by radio frequency hardware. Example modules include a PLCP module, a scrambler, an encoder, a puncturer, an interleaver, a mapper, a pilot insertion module, an OFDM module, and cyclic prefix and/or windowing modules. Other example modules/kernels convert a received baseband signal into a bitstream for consumption by a CPU or the like. In one example, an IEEE 802.11a transceiver is operated by the GPU-based software defined radio platform.

### BACKGROUND

Traditionally, radio communication products involve a lot of hardware development effort. Software defined radio (SDR) is a technology that uses software to implement physical layer wireless communication technologies, and thus turns many radio-related hardware development problems into software issues. This can shorten product development cycle, reduce costs, and make product distribution much easier. Moreover, software defined radio provides maximum flexibility and programmability, which can speed up the innovation in wireless communications.

At present, software defined radio platforms are either developed using Field Programmable Gate Array (FPGA) or a personal computer, with some radio front-end (hardware) that actually transmits the radio waveforms. However, FPGA has a very high learning curve and is difficult to develop; while conventional personal computer central processing units (CPUs) do not have enough processing power to fulfill the real-time requirements of digital communication algorithms.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards using a graphic processing unit (GPU) as a programming platform to implement radio communication technologies. A software defined radio platform is implemented via a graphics processing unit (GPU). The GPU includes modules, corresponding to kernels, that process an incoming bitstream (e.g., from PC memory) into baseband signals for output by radio frequency hardware. Example modules include a PLCP module, a scrambler, an encoder, a puncturer, an interleaver, a mapper, a pilot insertion module, an Inverse Fast Fourier Transform module, and cyclic prefix and/or windowing module. These example-modules consist of a wireless communication transmitter based upon Orthogonal Frequency Division Multiplexing (OFDM) technology.

Other example modules/kernels convert a received baseband signal into a bitstream for consumption by a CPU or the like. Example modules include a timing detection module, scrambler module, cyclic prefix removal module, a Fourier transform module, an equalizer module, a pilot correction module, a demapper module, a deinterleaver module, a depuncturer module, a decoder module, and/or a descrambler module. These example-modules consist of a wireless communication receiver based upon Orthogonal Frequency Division Multiplexing technology.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example system architecture/environment for implementing software-defined radio platform based upon a graphics processing unit.

FIG. 2 is a block diagram representing various example modules for implementing OFDM procedures to provide a software-defined radio platform based upon a graphics processing unit (GPU).

FIG. 3 is a block diagram representing the communication of a bitstream between the graphics processing unit and PC memory, and a baseband signal between the graphics processing unit and RF hardware.

FIG. 4 is a block diagram representing CPU modules and GPU kernels, including kernels comprised of merged modules.

FIG. 5 is a representation of processing data for scrambling.

FIG. 6 is a representation of scrambling sequence extension.

FIG. 7 is a representation of memory accesses in scrambling.

FIG. 8 is a flow diagram representing example steps in scrambling processing.

FIG. 9 is a representation of convolutional encoding.

FIGS. 11A and 11B are representations puncturing schemes using in processing a bitstream into a baseband signal.

FIG. 12 is a representation of convolutional encoder parallel design.

FIG. 13 is a flow diagram representing example steps in puncturing processing.

FIG. 14 is a representation of data structures and memory usage in scrambling.

FIG. 15 is a flow diagram representing example steps in interleaving processing.

FIG. 16 is a representation of data structures and memory usage in interleaving.

FIG. 17 is a flow diagram representing example steps in mapping processing.

FIG. 18 is a representation of constellations used in mapping.

FIG. 19 is a flow diagram representing example steps in pilot insertion processing.

FIG. 20 is a representation of data structures and memory usage in pilot insertion.

FIG. 21 is a representation of a data frame after cyclic prefix and windowing processing.

FIG. 22 is a flow diagram representing example steps in windowing processing.

FIG. 23 is a representation of data structures and memory usage in windowing.

### DETAILED DESCRIPTION

Various aspects of the technology described herein are generally directed towards a software defined radio platform that uses a graphic processing unit (GPU) as a programming platform to implement radio communication technologies. Contemporary GPUs, which traditionally are used as a dedicated graphics rendering device for a PC, workstation, or game console, have more than ten times the processing power of contemporary CPUs. As will be understood, the parallel hardware architecture of a GPU is suitable for many signal processing algorithms that are inherently parallelizable. Further, parallel programming languages for GPU resemble and/or are extensions of the C programming language, which makes programming for GPU execution much easier than programming FPGAs.

While the examples described herein are directed towards GPU operation, it is understood that any sufficiently powerful multicore processor with a parallel hardware architecture may be equivalent with respect to the technology described herein. Further, while some of the examples are directed towards the parallel design and implementation of an IEEE 802.11a transmitter, (in which IEEE 802.11a is a popular wireless technology with high computation requirements), which has been implemented on a GPU that executes the IEEE 802.11a transmitter baseband process in real-time, it is understood that other implementations may be used, and that the use of a GPU in software defined radio is not limited to IEEE802.11a implementations. Still further, a CUDA-specific (NVIDIA CUDA™) parallel implementation is described, but this is only an example, as other programming environments may be used. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and software defined radio in general.

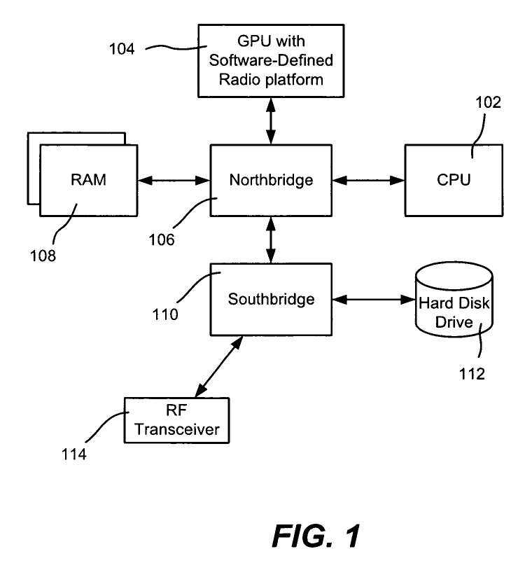

Turning to FIG. 1, there is illustrated a system architecture/environment of one example GPU-based software defined radio platform. In general, in this example, this is a software defined radio platform within a personal computer architecture. However, in this example, the CPU 102 primarily processes sequential algorithms, while the GPU 104 handles the algorithms that can be parallelized, at least those with respect to software defined radio. Shown for more context in FIG. 1 is a Northbridge 106, RAM 108, Southbridge 110 and hard disk drive 112.

To enable transmitting and receiving of the output signal computed in the GPU, a radio frequency (RF) transceiver front-end is installed (e.g., as a card), as represented by the RF transceiver 114. The RF transceiver 114 handles analog-to-digital and digital-to-analog (AD/DA) conversion, baseband to Intermediate Frequency or/and Radio Frequency conversion, and the actual waveform transmission/reception. The GPU 104, CPU 102, and RF transceiver 114 may be inter-connected through a high speed PCI-E bus to ensure high throughput and real-time information delivery among those devices. For example, the communication between the CPU 102 and the GPU 104 though PCI-Express (PCI-E) 1.1 can support the speed of 4 GB/s in both directions.

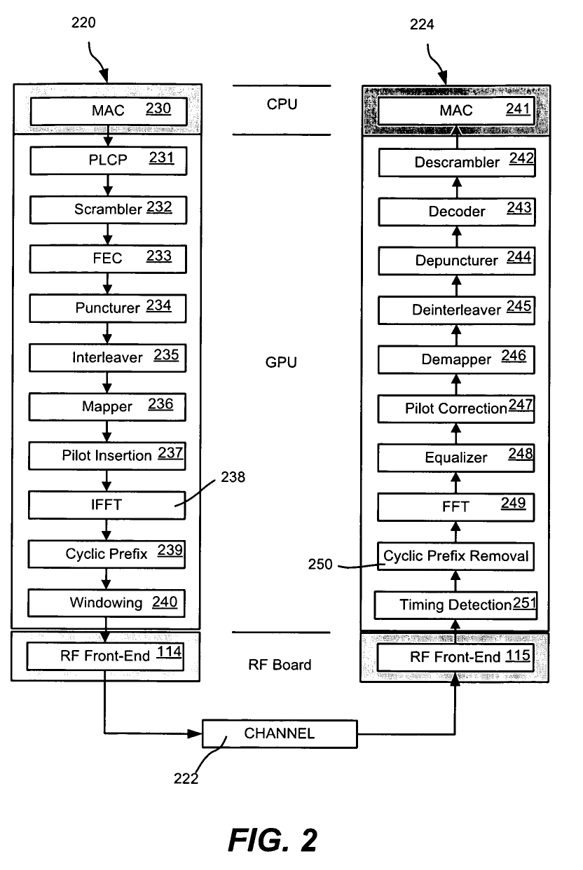

FIG. 2 shows various modules and/or procedures used to implement IEEE 802.11a PHY modules at the CPU, GPU and RF board levels. The left side 220 shows modules 231-240 for transmission to a counterpart device via a communications channel 222 established between devices, while the right side 224 shows modules 242-251 for reception at the counterpart device. The roles and operations of the various modules are described herein.

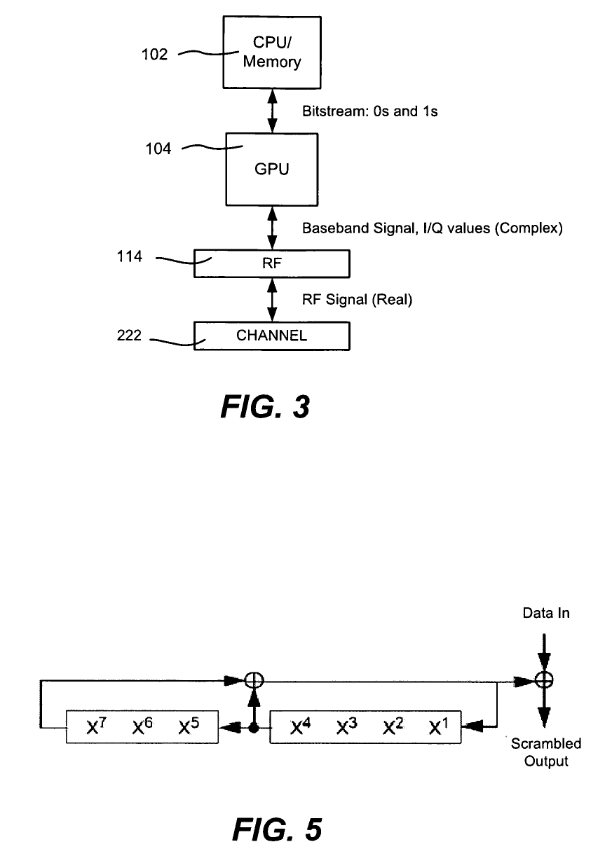

As generally represented in FIGS. 2 and 3, the CPU 102 transmits (and receives) a bit stream located in memory to (and from) the GPU 104. This bit-stream corresponds to the data in a MAC frame 230, 241. The GPU 104 processes the incoming bitstream and outputs the baseband signals, i.e., I/Q values. I/Q are the in-phase and quadrature phase components of radio waveforms, as generally represented in FIG. 3. The RF front-end 114 transmits the radio signals in the air, over the channel 222. As described below, the GPU 104 handles the generally most computation-intensive tasks of wireless communication to provide a GPU-based SDR platform.

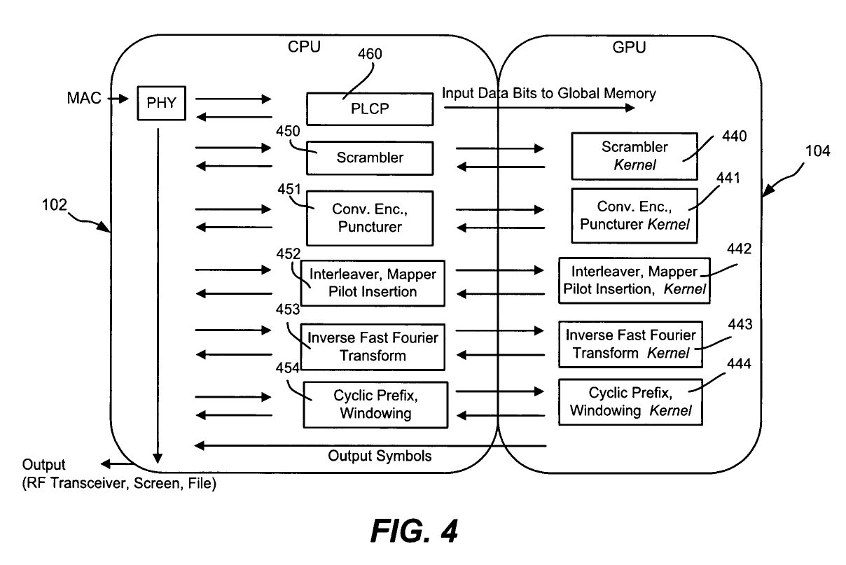

FIG. 4 describes one suitable software structure of an 802.11a PHY transmitter. As shown, for each kernel running 440-444 on the GPU 104 (a kernel is a maximum program unit running in a GPU, which generally correspond to one or more of the modules in FIG. 2), there is a corresponding CPU function block 450-454. There is a close interaction between the CPU 102 and the GPU 104 between each kernel call. Note that only one kernel runs at the same time on the GPU 104, which makes kernel calls a sequential process. Further, note that relative to FIG. 2, some kernels correspond to a single PHY module, whereas other kernels correspond to multiple PHY modules that have been merged; merging modules into one kernel where appropriate distributes the overhead of a kernel call, on the order of about 15 μs.

An API or interface to the MAC layer is provided. Each caller function needs to include the phyIF.h header file. This interface enables the MAC layer to interact with the PHY. Sending data requires that caller initialize the sending process by providing the PHY with transmission parameters:

bool PHY SendRequest(txvector* PHY TXVector);

The PHY TXVector includes the length of the frame that will be sent, the data rate, the service (for future use), the transmission power level and the channel number.

typedef struct {
unsigned short int length;
unsigned short int datarate;
unsigned short int service;
unsigned short int txpwr level;
unsigned short int tx channel;
} txvector;

After the initialization is completed, data can be sent, by providing a pointer to the input array. This array is an array of integers, where the 32 bits of each integers represent valid data.

bool PHY SendData(int* inputData);

As represented in FIG. 4, a physical layer convergence procedure (PLCP) module 460 takes the MAC frame and transforms it into a specific format for two devices to communicate at the physical layer. The PLCP integration module 460 is sequential. It is mainly a sequence of calculations and table lookups that are done once for the whole frame; there is no bit-wise or integer-wise operation. As a result, the CPU 102 may be used for these calculations, because the processor clock rate is much higher (3.2 GHz) than each of the GPU processors taken separately (1.35 GHz), and also because of the inherent multi-threaded architecture of the GPU.

A role of the scrambler 232 (FIG. 2) in 802.11a is to randomize the distribution of ‘1’ and ‘0’ in the input bitstream, including to eliminate long sequences of ‘0’ or ‘1’. This is especially useful in hardware for synchronizing purposes. In some digital baseband modulations (or line codes), there may be no amplitude transitions between each bit in a series of 1s or 0s, so that clock drift might be observed. In other words, the hardware may get an imprecise estimation of the start of each bit. Another role is eliminating the dependency of a signal's power spectrum upon the actual transmitted data. This is in order to obtain a power spectral density (PSD) with relatively identical levels in each OFDM (Orthogonal Frequency Division Multiplexing) symbol. This avoids potentially high interferences if one symbol has high amplitudes, while the neighboring symbol is weaker.

The main operation of a scrambler is to XOR the input bit stream with another sequence of bits called the scrambling sequence. This scrambling sequence is generated with a state-machine represented by a shift-register. FIG. 5 shows the shift register representation. The scrambling sequence depends on its generator function and the initial state. In 802.11a, the generator function is:

S(x)=r⁷+x⁴+1

where S(x) is the output bit and each power of x represents an element of the 7-bit shift register.

The initial state needs to be a pseudo-random non-zero value. Indeed, a zero-value initial state would yield an all-zero scrambling sequence, which would have no effect on the input bit stream. After the scrambling process, the 6 tail bits at the end of the frame are set back to zero. These 6 bits are used later in the coding module, to ensure that the convolutional encoder state machine's final state is the all-zero state. This improves the decoding accuracy.

Scrambling is generally a rather sequential process. For each input bit that arrives, a corresponding scrambling bit is generated and both are XORed. This is one way to implement a scrambler in hardware. According to the standard, an IP packet is to be ready before it is handed in to the MAC layer. Then, the MAC layer usually provides the PHY layer with the MAC frame in individual segments of one byte. However, this approach can be replaced with a MAC layer that provides the PHY with a pointer to the full MAC frame at once, whereby the whole frame is available at once.

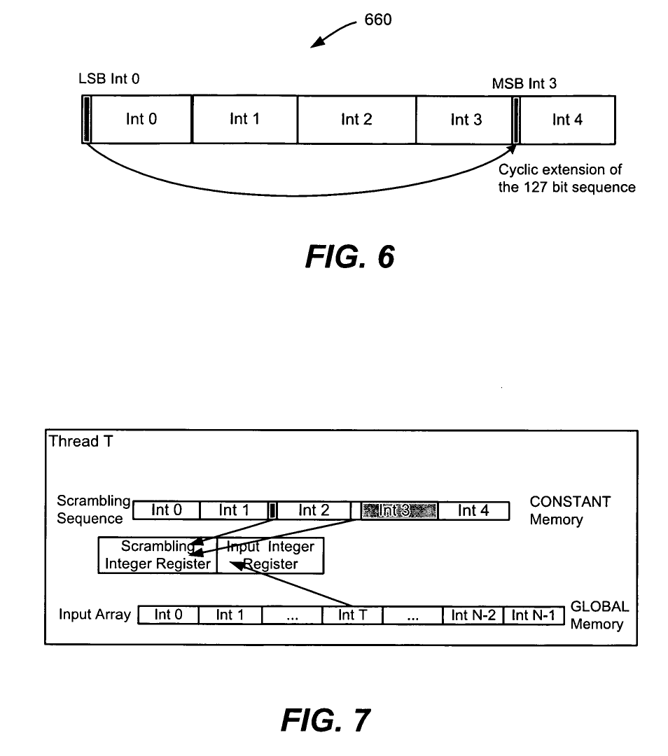

As generally represented in FIGS. 6 and 7, the scrambling sequence has a length of 127 bits, which is not an integer multiple of 32. It is stored in an array of integers 660. The representation of the input is an array of integers, out of which every 32 bits are valid information bits.

Given the above, parallelization is achieved over the whole frame, by dividing the frame in shorter segments that are processed independently. The segment size is 32 bits (one integer). To enable parallelization, the scrambling sequence is pre-calculated. The 32 bits from the scrambling sequence corresponding to the current segment need to be identified. The 32 input bits are XORed with 32 bits of the scrambling sequence.

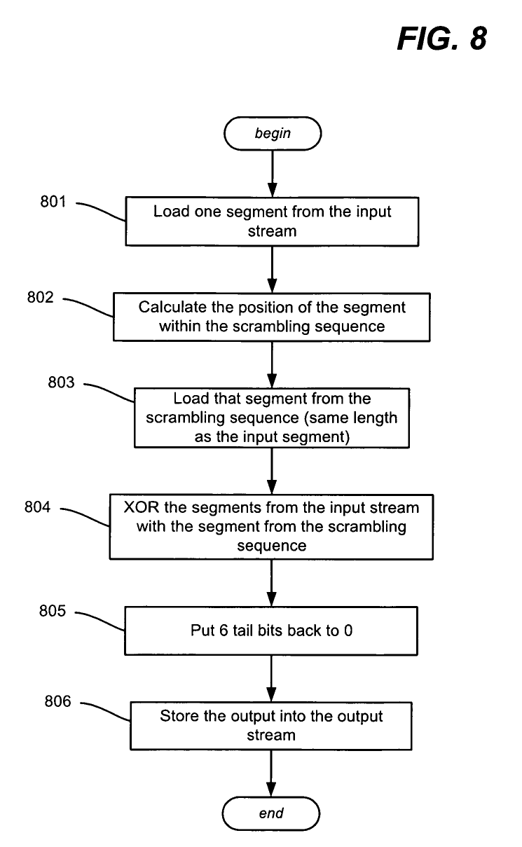

A high-level description of scrambling, for one thread tx among many other threads (which is executed in parallel), is presented in the flow diagram of FIG. 8 as set forth below and in the form of pseudo code provided in algorithm box 1.
Step 801: Load one segment from the input stream.
Step 802: Calculate the position of the segment within the scrambling sequence.
Step 803: Load that segment from the scrambling sequence (same length as the input segment).
Step 804: XOR the segments from the input stream with the segment from the scrambling sequence.
Step 805: Put 6 tail bits back to 0.
Step 806: Store the output into the output stream.

Algorithm 1 Scrambler for thread tx

```
Require: an array I of integers, an array S of integers
Ensure: an array O of integers
  1: in_seg [symbol]  I[tx]
  2: pos [symbol]  correct segment in S
  3: scr_seg [symbol]  S[Pos]
  4: out_seg = in_seg XOR scr_seg
  5: if out_seg contains tail then
  6:  out_seg [symbol]  out_seg AND tail
  7: end if
  8: O[tx] [symbol] out_seg
```

Turning to aspects related to mapping to the CUDA programming platform and threads and thread blocks, each integer-segment from the input stream is processed by a different thread. The maximum length of an Ethernet MAC frame is 1518 bytes, which corresponds to a PLCP data frame of 385 integers. Accordingly, the algorithm requires up to 385 threads. To enable enough occupancy and take advantage of the parallelism of the hardware, small thread block are desirable. In one implementation, one WARP (32 threads, which is the execution granularity) per thread block has been identified as the best trade-off and will use up to 13 MPs (385/32=12.03125, rounded up). Some threads of the last thread block might be unused.

The input array is an array of integers stored in global memory of the GPU. The output array is an array of integers stored in global memory, the same length as the input array. The scrambling sequence may be pre-calculated offline for each 2⁷−1=127 initial states and stored in constant memory (GPU cache) to speed up the processing. The scrambling sequence is an array of unsigned integers; unsigned integers are generally preferred to signed integers, as right-shift operations on signed integers append 1 s on the most significant bits (MSBs) if the integer is negative. This would require applying an additional mask to put the 1s that appear back to zero, before being able to apply a bitwise-OR to insert bits from two integers into a single new integer.

One optimization is that the scrambling sequence is stored in an array of five unsigned integers in constant memory, instead of four. The fifth integer contains a cyclic extension of the sequence. This approach enables reducing branching, when integer 3 and 0 (by cyclic extension) have to be read. Instead of reading integer 3 and 0, integer 3 and 4 will be read, as generally represented in FIG. 6. With pre-calculating the scrambling sequence, the table has a size of 127*5 integers. Before the kernel is launched, the scrambling sequence is transferred to constant memory.
1. Each thread loads its own input integer from global memory to a register.
2. The identification of the correct integer from the scrambling sequence includes calculating the bit and integer index of the first bit within the scrambling sequence that is to be XORed with the threads input integer. It costs a simple division and 2 modulo operations.
3. The 32 bits may correspond exactly to one integer. However, the thread might need to merge bits from two integers into one single integer. This requires 2 bit shifts and bitwise ORs operations to form a single integer. Moreover, branching will happen, as some threads need only one integer from the scrambling sequence, some two.
4. The input integer and the scrambling integer are XORed.
5. A mask consists in two integers calculated in CPU that are given as argument to the kernel call. By ANDing the two mask integers and the corresponding two output integers, 6 corresponding bits are put back to 0. This is achieved by two contiguous threads. Branching happens here of course with one WARP (or half-WARP).
6. The output integer is stored back to global memory in a coalescent fashion. d outputFrame[tid]=myOutputInt;

In one example implementation, a WARP (32 threads) is the execution granularity unit. to use more than one WARP per block provides 385/32=12.03125 blocks, rounded up to 13 blocks, which will yield less than one thread block per multiprocessor (MP). In other words, the GPU utilization seems too low. Thus, it is desirable to have more thread blocks (and less threads per block) to make use of all the MPs. Using just a half-WARP per block has been tried (25 blocks), but the performance results are identical to the full WARP approach. This is generally because although utilization of the GPU may have increased (at most doubled), only half of the threads of a WARP were processing data.

In one example implementation, another approach to parallelization has been attempted. Each thread was mapped to one integer from the scrambling sequence, and identified the corresponding integer in the input stream. The drawbacks are potential race conditions when storing into the output integer stream. Indeed, some output integers will have to be written by two different threads. As race conditions are difficult or costly to deal with in shared memory or global memory, this approach has been rejected at the end.

With respect to scrambling sequence generation, the scrambling sequence is usually calculated in real time, one bit at a time, with a state-machine. The scrambling sequence depends on the initial state, which is pseudo-randomly chosen. However, to enable parallelization, the full sequence needs pre-calculation. One approach was to calculate it in the CPU 102 before the kernel launch, as the CPU clock speed is much higher than the GPU's clock frequency, and as this the generation is a purely sequential process. However, given that there are only 2⁷−1=127 possible scrambling sequences, each 127 bits long, it is possible pre-calculate all of them and store them into a two-dimensional integer array of size 127×5. At run-time, the scrambling sequence generation is reduced to a simple CPU table lookup, which is very inexpensive. This approach represents a trade-off between number of operations and memory accesses.

Basically, the scrambling sequence is shared data. Many threads need to access the same scrambling sequence. However, as every thread only needs two integers (at most), the corresponding integers may be stored in two registers. This speeds up processing without restricting the occupancy of the GPU. From host memory, the scrambling sequence is copied to constant memory instead of global memory as an intermediate storage. In practice, a slight performance improvement can be obtained this way (around 0.5 μs per frame).

Convolutional codes are a type of forward error correction that improves the performance of a digital data transmission. Because the transmission channel may corrupt the transmitted signal, the sender adds redundant data into the transmitted bitstream, so that the receiver can proceed with error detection and error correction (to a certain extent) from the corrupted signal. This reduces the chance the sender resends the frame, which is beneficial in environments where retransmissions are costly or not suitable.

In theory, an information symbol of N bits is transformed into an encoded symbol of M bits. The ratio N/M is called the code rate r of the encoder. In 802.11a, the symbol is a single bit, and the coding rate is r=1/2, which means that at each instant, for one input bit, there will be two output bits. As a result, the output bitstream is twice as long as the input bitstream. Another aspect is the constraint length K of the code, which represents how many (previous) information bits are used to calculate the current output bits. In 802.11a, K is seven, which means that at each instant, the two output bits will be a function of seven bits before in the input bitstream.

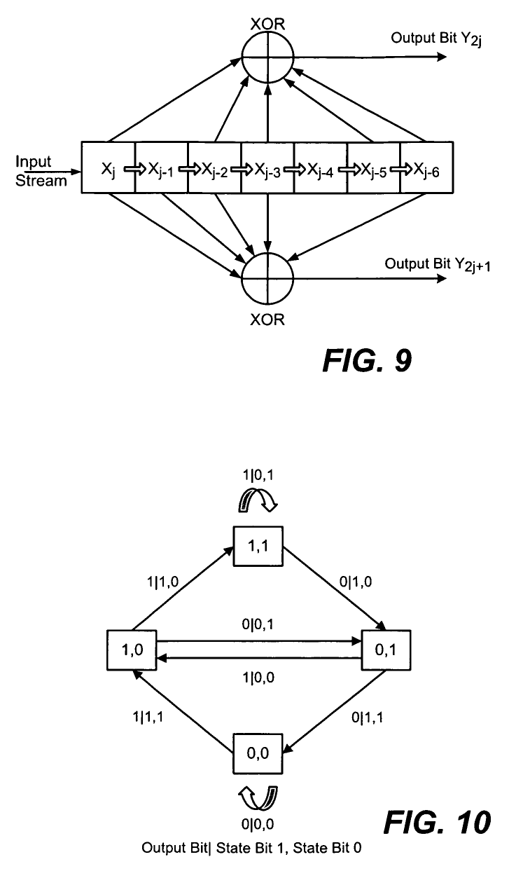

Thus, a convolutional encoder (FEC 233, FIG. 2) may be considered a 7-bit shift register, containing the seven bits from which, at each moment, the two output bits are calculated. At each step, the registers are shifted by one position to the right. As generally represented in FIG. 9, each register is linked or not to one of the output XOR boxes. For example, the output bit Y2j is a function of input bits Xj-6,Xj-5,Xj-3,Xj-2,Xj. The links can be represented by an array of seven bits, with bits set to one (1) if the link exists, or zero (0) otherwise.

Another additional consideration is the header processing. The header has a separate convolutional encoding process. Its state machine starts at all-zero and the six tail bits in the header enable to decode it with highest performance. One alternative model for a convolutional encoder is a state machine with 64 states (2⁶ states, so six bits represent a state). FIG. 10 shows a state machine of K=3 convolutional encoder, demonstrating that the convolutional encoder is in principle a purely sequential process; the state at time T depends on state at time T-1 and on one input bit. Note that before starting the encoding procedure, the initial state is all-zero (six zeros). Moreover, to improve the performance at the decoding stage, the last six bits, the tail bits, are also set to zero.

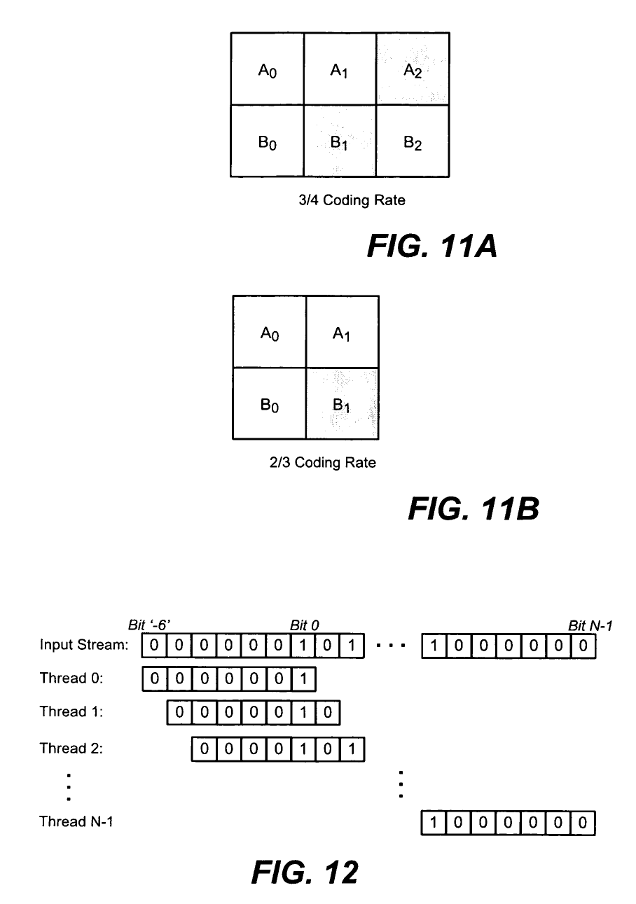

A role of the puncturer 234 (FIG. 2) is to adapt the coding rate according to the data rate that is desired. The puncture module 234 is placed right after the convolutional encoder 233 (FIG. 2). Basically the puncturer 234 omits some bits of the coded bit stream to increase the initial code rate (e.g., 1/2) to 2/3 or 3/4; (this is generally represented in the schemes in FIGS. 11A (3/4) and 11B (2/3), where shaded bits are omitted). Together with different modulations schemes, puncturing enables obtaining various transmission data rates. At the receiver, the omitted bits are replaces by zeros; puncturing decreases the decoding performance, as the punctured bits may be wrong.

Assume that the full frame is available at once, in one implementation the input data stream is an array of integers of variable length. Each integer represents 32 information bits which are shared. Generator masks are one integer each, and are shared. The output data stream is an array of integers of variable length. Each integer carries 32 coded bits. The length of this array depends on the length of the input array and the coding rate.

Parallelization is achieved per state of the state machine. The input stream is divided in segments of seven bits, and each segment calculates the output bits in parallel. Compared to segment i-1, segment i's position within the input stream is shifted by one position to the right, as generally represented in FIG. 12. For N input bits, there are N parallel threads. The corresponding seven input bits are XORed with two generator masks to yield two output bits, which are stored into an output array.

The puncturer parallelization is achieved by removing one bit in a set of two bits (Aᵢ and Bᵢ, in FIGS. 11A and 11B) in parallel, depending on the position within the puncturing scheme. In the 3/4 coding scheme, for position zero (0), A₀ and B₀ are stored; for position one (1), A₁, for position two (2), B₂.

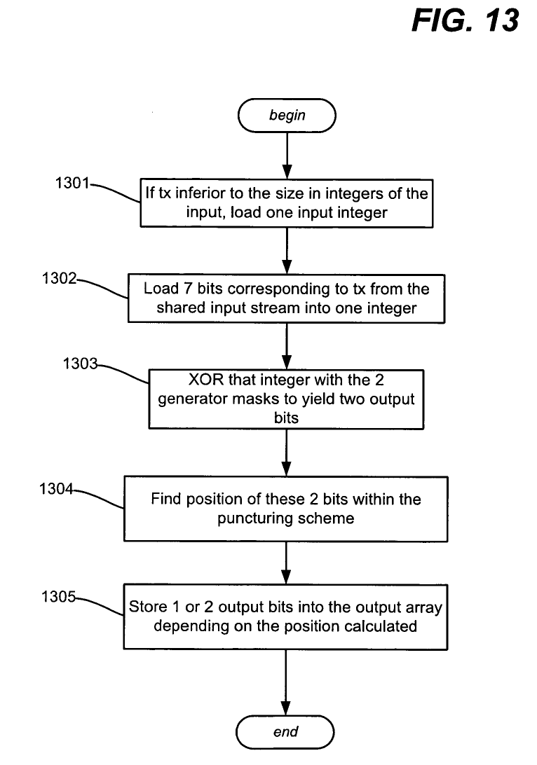

A high-level description for a thread tx is presented in the flow diagram of FIG. 13, as set forth below and in the form of pseudo code provided in algorithm box 2.
Step 1301: If tx inferior to the size in integers of the input, load one input integer.
Step 1302: Load 7 bits corresponding to tx from the shared input stream into one integer.
Step 1303: XOR that integer with the 2 generator masks to yield two output bits
Step 1304: Find position of these 2 bits within the puncturing scheme.
Step 1305: Store 1 or 2 output bits into the output array depending on the position calculated.

Algorithm 2 Convolutional Encoder and
Puncturer for thread tx, 3/4 scheme

```
Require: an array I of integers, two integers G1 and G2, an array of
integers T
Ensure: an array O of integers
  1: if tx < length(I) then
  2:  s_I[tx] [symbol] I[tx]
  3: end if
  4: reg_I [symbol]  bits tx-6 to tx from I
  5: out1 [symbol]  reg_I “XOR” G1
  6: out2 [symbol]  reg_I “XOR” G2
  7: punctPos = tx mod 3
  8: outputPos = tx*4/3
  9: if punctPos = 0 then
10:  O[outputPos] = out1
11:  O[outputPos+1] = out2
12: else if punctPos = 1 then
13:  O[outputPos] = out1
14: else if punctPos = 2 then
15:  O[outputPos] = out2
16: end if
```

The convolutional encoder 233 and puncturer 234 may be merged into one single kernel 441 (FIG. 4), whereby they both operate with the same number of threads and blocks. Each thread is responsible for computing results in one time step within the state machine. In other words, each thread will read seven bits from the input stream and output two bits. Thread 0 will read X₋₆ to X₀, thread 1 the bits after a shift of one position, i.e., X₋₅ to X₁, and so forth. In theory, there are as many threads as input bits; in practice, each thread block has 192 threads to yield the “best” performance. In the last thread block there might be empty threads if the input stream is not an integer multiple of 192.

A branching condition is used in the last block. The header is processed separately than the frame itself. One mechanism to reduce branching is to have a dedicated thread block. The additional thread block will have similar code to execute, but on a different input data array. This corresponds to an IF-ELSE clause within the kernel code to separate the thread blocks, which adds a very small overhead.

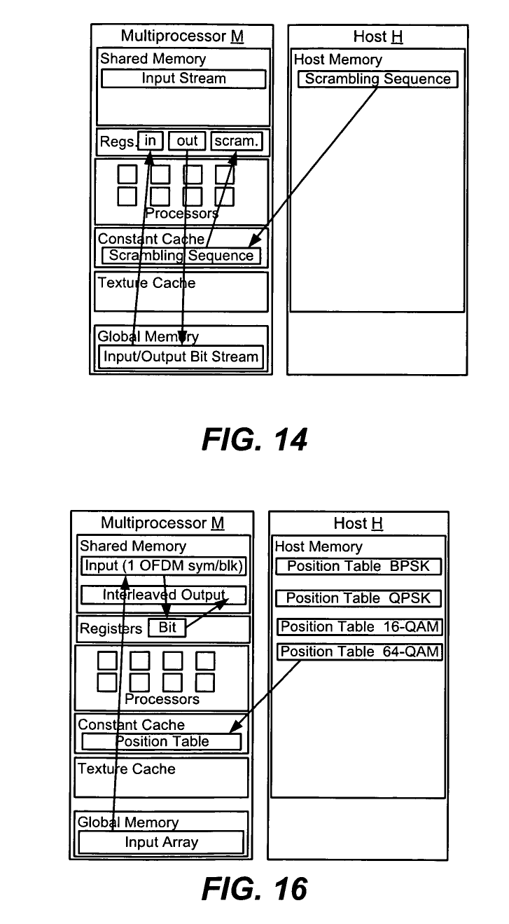

The input data stream is an array of integers of variable length. Each integer represents 32 information bits. As generally represented in FIG. 14, it is first stored in global memory, then transferred to shared memory, where it is shared among the threads. Generator masks are stored directly in two registers. The output data stream is an array of integers of variable length. Each integer carries 32 coded bits. The length of this array is the length of the input array times the coding rate. It is stored in global memory.
1. Every thread whose threadID tx is below the length in integers of the input dealt with in this block, loads one integer into the shared input array, at position tx+1. Then, the last thread of the block will load either 0 or the last integer of the last block into s array[0]. This integer is used to enable the encoding the first 6 bits of the first integer of this block. This method also reduces branching.
2. If threadID mod 32 is lower than 6, the 7 bits are contained in two contiguous integers. So, their position needs to be identified. Then the two integers are shifted accordingly, so that the two integers are ORed to yield a single integer which the 7 bits as LSBs. If threadID % 32 is above 6, the 7 bits are situated in one integer. This integer is shifted so to have the 7 bits in LSB. No need for masking.
3. Then the 7 bits are to go through the XOR module. The integer containing the 7 bits bitwise ANDed with the generator masks. The resulting integer is used as the index of a table in constant memory called tableONBits table. This table's elements represent the number of bits that are equal to 1 for all integer between 0 and 27−1, modulo 2. This is exactly the XOR output needed. For example, for 3 (0b11) the output is 2 mod 2=0, for 4 (0b100) the output is 1 mod 2=1 and so forth.
4. First the different coding rates are separated. Then, the position of the two output bits within the puncturing scheme are calculated with modulo operation. The 3/4 scheme consists in 3 positions, 2/3 scheme in 2 positions, 1/2 scheme in a single position.
5. In the 3/4 coding scheme, for position 0, the two bits are stored, for position 1, the first bit, for position 2, the second bit. For the 2/3 scheme, position 0, the two bits are stored, for position 1, only the first bit is stored. For the 1/2 scheme, all the output bits are stored. This involves a lot of branching and is hard to map perfectly to the SIMD architecture.

One approach is directed to require as many threads as there are steps within the convolutional encoder state machine. In other words, there should be as many threads as input information bits. However, the division in thread blocks limits this approach so that 192 threads per thread are used. So, empty threads will be found in the last block, if the input stream length is not an integer multiple of the block size. Experimental results show that having 128, 192 or 256 threads per block yield the best performance. This is likely because 128, 192 and 256 are an integer multiples of the WARP size. Then considering that there are at most 768 threads per multiprocessor and that 128, 192 and 256 are exact divisors of 768, the kernel can potentially fully use the GPU. Moreover 128, 192 or 256 threads per block correspond to 6, 4, 3 blocks per multiprocessor, which enables shared resources like shared memory and registers to be sufficient to have all the blocks running concurrently.

The two generator masks that correspond to the links between the shift register and the XOR blocks are read at the same instant by all the threads. This makes them suitable for constant memory. However, the register approach, which does not require any copy from the CPU side to constant memory, yields better performance.

According to the position within the puncturing scheme, either one or two bits are actually kept as an output of the puncturer. The potential to parallelize here is limited. One thread out of three follows the same instructions. One solution is to save the two output bits from the convolutional encoder first to shared memory, and assign the bits that require the same instructions to contiguous threads. However, a problem is the amount of shared memory. A simple calculation is that if two bits are stored in shared memory, each in one integer, and there are two blocks of 192 threads in each multiprocessor (due to fifty percent utilization), the shared memory size needed is 192*2*64=24576 bytes. This is larger than the 16384 bytes of shared memory available on the current GPU. In future hardware with additional shared memory, this approach can be utilized to improve the performance.

The initial state of the convolutional encoder is all-zero. One option could have been to insert one integer in front of the whole frame at the PLCP module level. However, it turned out the be simpler and more efficient to insert the first integer as all-zero integer in this module, because other thread blocks also need to load one integer “from” former threads blocks.

Turning to the interleaver 235 (FIG. 2), a general objective of the interleaver is to improve the robustness of the system against bad channel conditions. Each OFDM symbol has 48+4=52 subcarriers. If some sub-carriers experience a lot of interference, while other sub-carriers experience better conditions, it is smart to distribute contiguous coded bits among different carriers. This way, via coding, correct data can still be estimated. Moreover, longs runs of LSBs or MSB of the constellation in one sub-carrier are to be avoided. An error on an MSB is more severe than one on an LSB, thus distributing the errors between bits from various positions reduces in average the severity of errors.

The interleaver 235 works in parallel across different OFDM symbols. In general, in one example interleaver algorithm there are two steps:
1. Adjacent coded bits are mapped into non-adjacent carriers

i=(N_{CBPS}/16)(k mod 16)+floor(k/16), k=0, 1, . . . , N_{CBPS}−1

with k being the index of the input bit, i the new index for the bit, and N_{CBPS} the number of Coded Bits Per Subcarrier.
2. Adjacent coded bits are mapped alternatively onto less and more significant bits of the constellation,

$$j = s * floor ( \frac{i}{s} ) + ( i + {N}_{CBPS} - floor ( 16 * \frac{i}{{N}_{CBPS}} ) mod s , \\ i = 0 , 1 , … , {N}_{CBPS} - 1$$

with i the index of the bit from the first step, j the new index for the bit after the second step, NCBPS the number of Coded Bits Per Subcarrier, s=max(N_{BPSC}/2, 1), with N_{BPSC} being the number of Information Bits Per SubCarrier.

The algorithm assumes that the full coded frame is available at once. The input data is an array of integers corresponding each to 32 coded bits. The input data is not shared. The pre-calculated position table is an array of integers. The index of the elements corresponds to initial position k within an OFDM symbol. The elements of the array correspond to the final position j within an OFDM symbol. The table is shared within an OFDM symbol. The output array is an array of integers; here each integer represents one bit. The size is the size of the input array times the number of bits per integer (32). The output data is shared.

The input data process is parallelized per OFDM symbols. OFDM symbols can be processed completely independently without sharing data between each other. The two steps of interleaving described above are merged into one single position mapping. The calculation of the final position mapping j for each bit k is reduced to a single table lookup, instead of a calculation at run-time. The position table is pre-calculated for each modulation type (BPSK, QPSK, 16-QAM, 64-QAM). The header is also interleaved. It follows the same guidelines as the BPSK case.

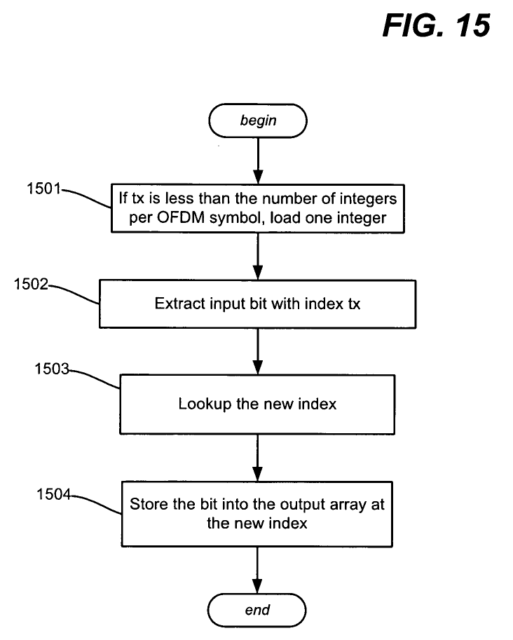

A high-level description for a thread tx is presented in the flow diagram of FIG. 15 as set forth below and in the form of pseudo code provided in algorithm box 3.
Step 1501: If tx is less than the number of integers per OFDM symbol, load one integer.
Step 1502: Extract input bit with index tx.
Step 1503: Lookup the new index.
Step 1504: Store the bit into the output array at the new index.

Algorithm 3 Interleaver for thread tx

```
Require: an array I of integers, an array of integers T
Ensure: an array O of integers
  1: if tx < length(I) then
  2:  s_I[tx] [symbol] I[tx]
  3: end if
  4: srcIntIndex [symbol]  tx / 32
  5: srcBitIndex [symbol]  tx mod 32
  6: bit [symbol]  s_I[srcIntIndex] >> srcBitIndex & 1
  7: newIndex = T[tx]
  8: O[newIndex] = bit
```

Each OFDM symbol is assigned to a thread block. Each bit within an OFDM symbol is assigned to a dedicated thread. A full Ethernet frame has 57 OFDM symbols (data part) if sent at 54 Mbps, which corresponds to 57 thread blocks of each 288 threads. This represents a good parallelization and occupancy of the 16 MPs. An additional thread block takes care of the header. It is chosen to be thread block 0, to optimize the pilot insertion module (described below).

As generally represented in FIG. 16, in CUDA, the input data is stored in global memory as an array of integers. In principle, it is shared among the threads, but in this algorithm, each thread will access independent integers. However, in the BPSK case, one boundary integer of the OFDM symbol is accessed by two separate thread blocks. This is because each OFDM symbol in BPSK consists in 48 bits, which are stored in 1.5 integers. The position table is an array of integers that is pre-calculated and stored in host memory. Four separate tables are stored, each corresponding to one type of modulation. During runtime the table is copied to constant memory, where it is shared by the threads within one multiprocessor. In other words, the constant memory is shared among a few thread blocks. The output bits are stored in shared memory, in an array of integers. This time, each bit will be stored in a separate integer element of the array. E.g., for 64-QAM, an array of 288 integers for 288 bits is needed in shared memory. The reason the output bits are stored in shared memory is the integration of the interleaver module 235 and modulation module 238 into one single kernel 442.
1. First, the input data (integers) will be loaded from global memory to shared memory with the number of threads corresponding to the number of integers needed to store one full OFDM symbol.
2. The algorithm will calculate the initial position (integer, bit within integer) of the bit within the OFDM symbol.
3. Then it will look up the new position on the position table in constant memory.
4. Finally it will store the data bit into an output array in shared memory.

A typical approach to transmit an array of data to a register is to copy it first from host memory to global memory. Then it is copied from global memory to shared memory if it needs to be shared, otherwise directly from global memory to a register. In the example herein the data needs to be shared, so the shared memory approach has been tried. However, it turned out, and it is a general observation done in each kernel, that bypassing the global memory step by directly copying data from host memory to constant memory, without copying it to shared memory, proves to give slightly better performance.

As mentioned above, the modulation module 238 and the interleaver module 235, having a similar parallel approach per OFDM symbol, are merged; the merging of these two modules showed a high performance improvement because no intermediate storage in global memory between kernels is needed; shared memory can be used instead. Moreover, the output can be stored as 1 bit per integer. This technique enables reducing the bit-shift and masking operations inherent to the 32 bits per integer storage approach. Also, the overhead of launching a second kernel is avoided.

Turning to the modulation/mapper module 236, a bit stream cannot be sent on a wireless link in the form of bits, but rather requires modulation to convert the bitstream into a form that enables transmission of information on a channel. A principle of one type of modulations scheme is to convey data by modifying the amplitude of two carrier waves. These two waves, usually sinusoids, are out of phase with each other by 90 degrees.

Concretely, the mapper module 236 converts the bit stream into a stream of constellation symbols, which correspond to the coefficients applied to these two waves. In 802.11a, different modulations schemes are used. Each constellation symbol will represent 1, 2, 4 or 6 bits of the input stream, depending on the modulation type. For the modulation types, the number of constellation symbols sent on the channel per time unit is equal. As a result, the modulation type defines the actual data rate (bits/second) of the transmission.

Assuming that the full interleaved frame is available at once, the input bits are represented by an array of integers; they do not need to be shared. The lookup tables are arrays of floats of different sizes, depending on the modulation scheme. The tables are shared. The output is an array of I/Q values, with a length being the number of data subcarriers (48).

Data parallelism is achieved per constellation symbol. In other words, depending on the modulation scheme, the input stream is divided into segments of 1, 2, 4 or 6 bits. To map the bits to constellation symbols, a table lookup is used. The algorithm for the header is similar. The parallelism is also achieved per constellation symbol. However, the header is only modulated with BSPK.

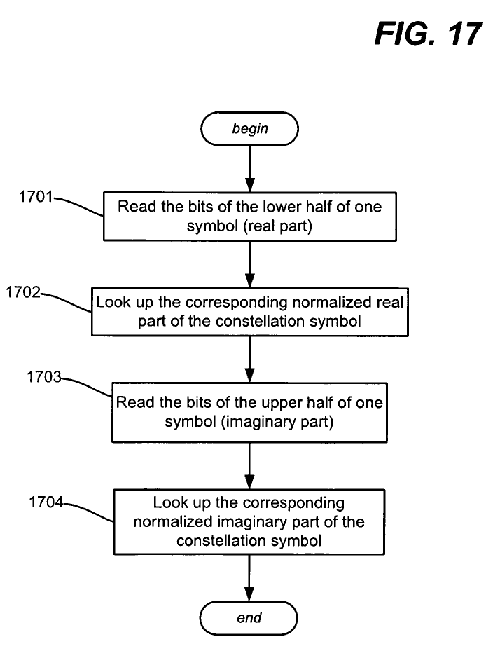

A high-level description for a thread tx is presented in the flow diagram of FIG. 17 as set forth below and in the form of pseudo code provided in algorithm box 4.
Step 1701: Read the bits of the lower half of one symbol (real part).
Step 1702: Look up the corresponding normalized real part of the constellation symbol.
Step 1703: Read the bits of the upper half of one symbol (imaginary part).
Step 1704: Look up the corresponding normalized imaginary part of the constellation symbol.

Algorithm 4 Mapper for thread tx < 48

```
Require: an array I of integers, an array of integers T
Ensure: a 2-element array O of floats
  1: myInput.real = I[tx*bitsPerSymbol];
  2: for i = 1 to bitsPerSymbol/2 do
  3:  myInput.real |= I[tx*bitsPerSymbol+i] << i;
  4: end for
  5: O[0] = T[myInput.real]
  6: myInput.imag = I[tx*bitsPerSymbol+bitsPerSymbol/2];
  7: for i = 1 to bitsPerSymbol/2 do
  8:  myInput.imag |= I[tx*bitsPerSymbol+bitsPerSymbol/2+i] << i;
  9: end for
10: O[1] = T[myInput.imag]
```

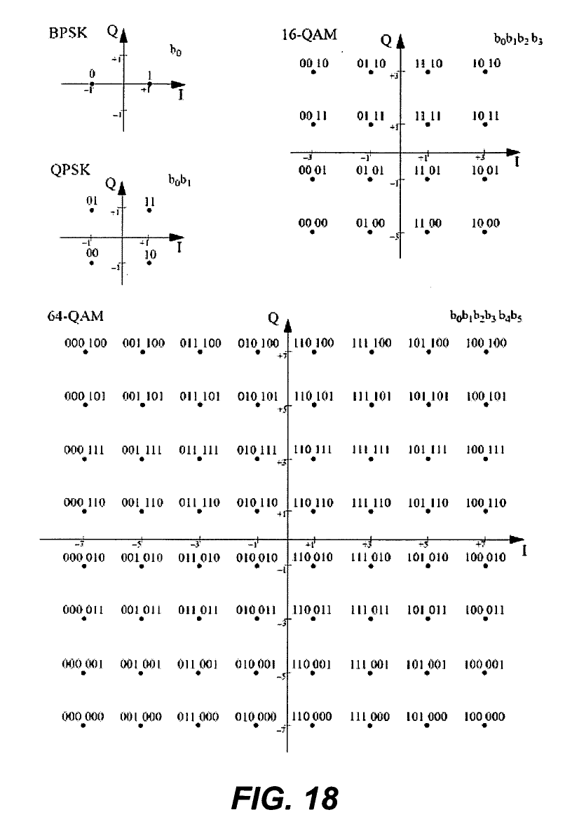

As two modules are merged (the interleaver and the mapper), the execution parameters (blocks, threads) are already given, namely one block per OFDM symbol and as many threads per thread block as there are bits per OFDM symbols. The mapper requires 48 threads per block. Indeed, each OFDM symbol consists in 48 information sub-carriers. In other words, each sub-carrier of an OFDM symbol carries one constellation symbol. In the case of BPSK, this number of threads (=48, the number of bits per OFDM symbol) is exactly the number of threads needed for the mapper. For the other modulations, many threads will remain idle. This involves a branching condition. However, as contiguous threads still perform the same instructions and the number of threads is a multiple of 16, there is no divergence within any half-WARP. Note that the header requires BPSK modulation and is processed in thread block 0. Constellations are shown in FIG. 18.

The input bits are represented by an array of integers in shared memory, where only one bit per integer is used. The length of the array depends on the modulation scheme. The input array is shared because of kernel merging, even if not accessed concurrently in this module. The lookup tables are optimized to one-dimensional arrays stored in constant memory. The index of the elements are the input integers, the elements are the corresponding I or Q values. I/Q values in the table are normalized amplitude modulations, so an integer representation is not suitable. Floating points are used instead, so that the tables are actually arrays of floating points.

The mapper is merged with the pilot insertion module, so that the I/Q value will not be stored into an array of I/Q values in practice. Each thread keeps its own I/Q value in two registers. The I/Q value is represented by a complex number, whose real part is the I value, the imaginary par the Q value. The complex number is implemented as an cufftComplex structure, which corresponds to an array of 2 floats (2*32 bits).

Each thread takes care of 1, 2, 4 or 6 bits from an integer array stored in shared memory. For QPSK and QAM modulations, before being able to perform table lookups, the bits are divided in two segments of equal size. The left segment corresponds to the real part (in phase), the right segment to the imaginary part (quadrature phase) of the constellation symbol. Each bit segment is merged into a single integer register, with bit-shift and OR operations.

The integer obtained represents an index in the lookup table. Note that for optimization purpose, in the BPSK and QPSK case, no table lookup is used, but rather an if-else clause. The floating point value is then stored in the output cufftComplex structure. To summarize, no table lookup is used in the case of BPSK/QPSK, but rather an if-else clause to determine the constellation symbol. Indeed, there are only two possible values for those modulations (1 or −1) so that simple branching is much faster than a memory access for a table lookup.

By differentiating the different modulation schemes with switch-case, the loop that reads the input bits may be unrolled:
for (int i=1; i<bitsPerSymbol/2; i++)

mySymbol.x |=s interleavedSymbol[tx*bitsPerSymbol+i]<<i;
which for 64-QAM becomes:

mySymbol.x |=s interleavedSymbol[tx*bitsPerSymbol+1]<<1;

mySymbol.x |=s interleavedSymbol[tx*bitsPerSymbol+2]<<2;

This considerably speeds up this part of the code, around 2.5 times. Indeed the overhead of the for loop (addition and comparison) is avoided

A general objective of pilot insertion to make the coherent detection at the receiver robust against frequency offsets and phase noise. The receiver usually uses the preamble to do frequency offset compensation, which corresponds to adding an estimation of the phase shift to every sample in frame. As this estimation is only performed at the preamble level, at the very beginning of the frame, this estimation may become less accurate when approaching the end of the frame.

Pilots are transmitted together with information data in each OFDM symbol. Using pilots enables to update the offset estimation at every OFDM symbol.

In practice, the pilot insertion module has two roles, namely adding pilot symbols to the input symbol stream and assigning the input symbols to the correct sub-carriers before entering the IFFT (Inverse Fast Fourier Transform) module 443 (FIG. 4).

The pilots are inserted at sub-carriers −21, −7, 7 and 21. Within one OFDM symbol, the values of pilots are identical for position −21, −7, 7, and inverted for position 21. The magnitude of the pilot varies from OFDM symbol to another. It follows the following sequence:

p0 . . . 126v=1,1,1,1,−1,−1,−1,1, . . . −1,−1,−,−1,−1,−1,−1,

This sequence is also stored on the receiver side, so that it can compare the received pilot to these values to estimate the phase offset.

An additional aspect is that the next module is the Inverse Fast Fourier Transform (IFFT) module 443. The IFFT module follows the following equation:

$$x [ k ] = \frac{1}{N} {\sum }_{n = 0}^{N - 1} {X}_{n} {e}^{\frac{2 πi}{N} nk}$$

$$k = 0 , … , N - 1$$

where n represents the sub-carriers, N is the number of sub-carriers, Xₙ the complex constellation symbols, k the sample index of the output signal, x[k] the output signal. In OFDM, the sub-carriers are distributed around a central frequency f_{c}. In baseband, the central frequency corresponds to f=0 Hz, which is why negative sub-carriers are provided; there is mismatch between the input coefficients expected by the IFFT module (X₀ to X₆₃) and the sub-carrier indexes used for the coefficient of OFDM (X−32toX31). To deal with this, the IFFT algorithm makes the assumption that the input signal is periodic (as well as the output). The periodicity is 64 samples for the 64-point IFFT. Thus, input samples −32 to −1 actually correspond to samples 32 to 63 by cyclic extension. The position mapping used in the cycle prefix module 239 takes this into account.

The full constellation symbol sequence is assumed to be available at once. The input is one constellation symbols, the position mapping table is a shared integer array of length 48, and the pilot sequence is as well a shared float array of length 127. The output is an array of constellation symbols having a length of an integer multiple of 64. It does not need to be shared.

Pilot insertion is intrinsically a sequential process. It comprises a position mapping within an array of constellation symbols and in the addition of pilots. The parallelism unit here is a constellation symbol. The first part resembles the interleaver block, so that a position table will be used to identify the final position of the input constellation symbol. The insertion of the four pilots is performed sequentially after the data symbols insertion. There is no parallelism possible here.

The frame header follows the same guidelines as the data part. The header OFDM symbol and the data OFDM symbols all comprise 48 constellation symbols. Also, from this module on, there is no distinction between header and data part in terms of algorithm design and data structure.

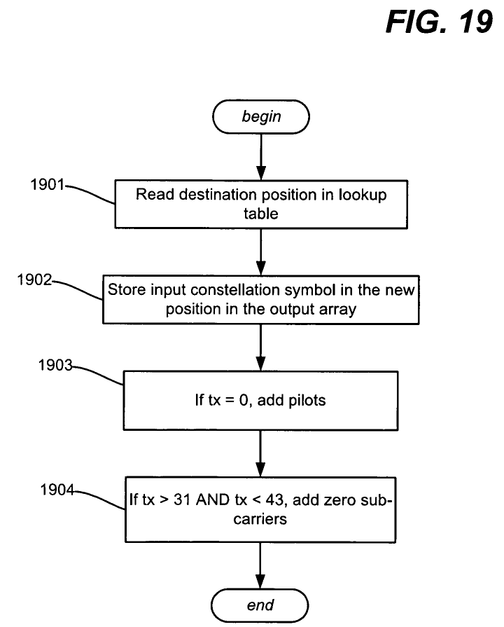

A high-level description for a thread tx is presented in the flow diagram of FIG. 19 as set forth below and in the form of pseudo code provided in algorithm box 5.
Step 1901: Read destination position in lookup table.
Step 1902: Store input constellation symbol in the new position in the output array.
Step 1903: If tx=0, add pilots.
Step 1904: If tx>31 AND tx<43, add zero sub-carriers.

Algorithm 5 Pilot Insertion for thread tx < 48, block bx

```
Require: a 2-element array I of floats, an array of integers T, an
array of floats P
Ensure: an array O of 2-element arrays of floats
  1: pos = T[tx];
  2: O[pos][0] = I[0]
  3: O[pos][1] = I[1]
  4: if tx=0 then
  5:  pilot = P[bx]
  6:  O[posPilot0][0] = pilot
  7:  O[posPilot0][0] = 0
  8:  O[posPilot1][0] = pilot
  9:  O[posPilot1][0] = 0
10:  O[posPilot2][0] = pilot
11:  O[posPilot2][0] = 0
12:  O[posPilot3][0] = −pilot
13:  O[posPilot3][0] = 0
14: else if tx > 31 AND tx < 43 then
15:  O[tx−5][0] = 0
16:  O[tx−5][1] = 0
17: end if
```

With respect to threads and thread blocks used when mapping to a CUDA programming platform, 48 threads will be used, one for each sub-carrier or constellation symbol. There is one thread block per OFDM symbol. The fact that the header is processed by the first thread block (block 0), front of the data thread blocks, there is no branching needed for the header processing. It simply follows the same instructions as the other thread blocks.

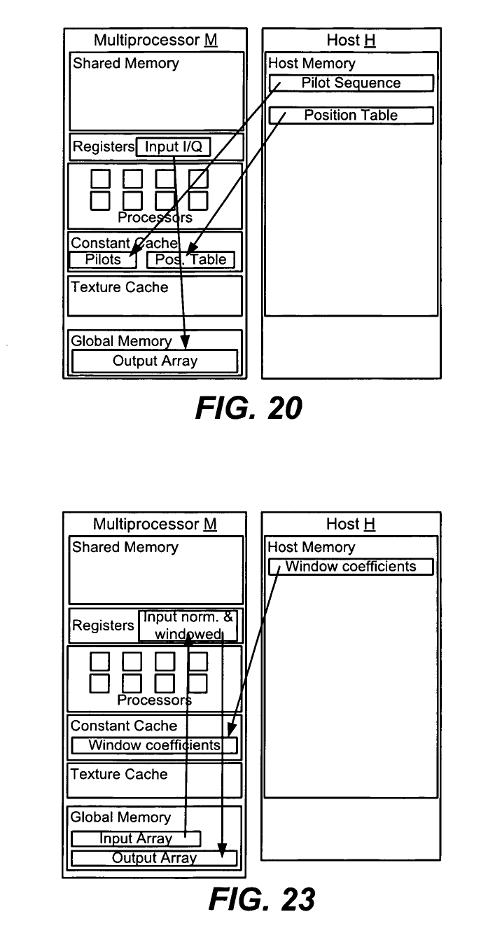

Due to merging of the kernels, the input array is actually not an array, but each thread already stored its own constellation symbol in registers. Each constellation symbol is represented by a cufftComplex symbol. A cufftComplex symbol is a two-element array of single-precision floating point numbers. In one implementation, the position table is pre-calculated offline and stored in host memory. It is an integer array of length 48. At runtime it is copied to constant memory where it is shared among threads of different blocks. The output is an array of cufftComplex symbols in shared memory, then in global memory. It is shared among all the thread, even if each thread only writes into independent array elements. Its length is an integer multiple of 64. As generally represented in FIG. 20, the pilot sequence is stored in host memory. It is an array of 127 floats as pilots are also constellation symbols. At runtime it is also copied to constant memory where it is shared among threads of different blocks.
1. Each thread already has its I/Q value in a register from the mapper module. A table lookup is performed in constant memory.
2. The constellation symbol is first stored in the right position in shared memory.

Then after synchronizing all the threads, thread tx will store pilot tx from shared memory into the global memory. This reordering to thread-symbol assignment enables coalescent memory transfer which drastically speeds up loading to global memory.
3. Thread 0, which is more likely to finish the first part before other threads, will deal with the pilot insertion. It will identify the pilot magnitude corresponding to the current OFDM symbol within the pilot sequence array. Then it inverts the last pilot and inserts the pilots into global memory. It also inserts zero-subcarriers to fill the 64 element IFFT input.

In general, the position table lookup significantly improves the performance of data symbol insertion. Pure SIMD is achieved. Further, storing the output in an intermediate storage in shared memory, reassigning threads, and then storing in global memory, permits coalescent transfer from shared to global memory. This can improve the storing process by up to ten times.

A main objective of OFDM modulation is to transform a frequency domain signal into its time domain representation. The current array of constellation symbols is the frequency representation of the transmitted signal. Each constellation symbol and pilot has been assigned to a sub-carrier to form a set of 52 sub-carriers. The OFDM modulation can be expressed a follows:

$${r}_{n} ( t ) = {w}_{sym} ( t ) {\sum }_{k = {N}_{SC / 2}}^{{N}_{SC} / 2 - 1} {d}_{k , n} exp ( ( j2π k {Δ}_{F} ( t - {T}_{GI} ) )$$

where n is the OFDM symbol index, k the sub-carrier index, NSC the number of subcarriers (52), dk,n the constellation symbol in the kth sub-carrier of the nth OFDM symbol, m the output time domain signal for OFDM symbol, _F the subcarrier frequency spacing (0.3125 MHz), TGI the guard interval time at the beginning of the OFDM symbol, and wsym a windowing function.

To map the OFDM modulation to the IFFT algorithm, first, 52 sub-carriers in OFDM do not represent an integer power of 2, which causes low performance of the IFFT. This is why the number of sub-carriers is expanded from 52 to the next integer power of 2 (64). So a 64-point IFFT has been chosen, and 12 zero sub-carriers are added. In OFDM, the sub-carriers are distributed around a central frequency fc. In baseband, the central frequency corresponds to f=0 Hz. There is a mismatch between the input coefficients expected by the IFFT module (X0toX63) and the sub-carrier indexes used for the coefficient of OFDM (X−32toX31). Still, it is possible to use the IFFT algorithm, because it makes the assumption that the input signal is periodic (as the well as the output). The periodicity is 64 samples for the 64-point IFFT. Thus, input samples −32 to −1 actually correspond to samples 32 to 63 by cyclic extension. The position mapping has been taken into account via the cyclic prefix module 239 (FIG. 2). It is assumed that the input data is available at once and that the size is an integer multiple of 64. The input data is an array of I/Q values (constellation symbols), that represent the frequency domain of the signal. The array is shared within each OFDM symbol. The length of the array is an integer multiple of 64. The output is an array of I/Q values that represent the time domain of the signal. The length of the output array is equal to the length of the input signal. This is a property of the IFFT (as described above). For this module, a divide-and-conquer algorithm such as the radix-2 Cooley-Turkey algorithm is suitable for the CUDA architecture, as it parallelizes the input stream by dividing it into segments of half length at each step, which can be mapped to Thread blocks, WARPs and half-WARPs. As the main algorithm is the preparation of the data, which has been achieved already in the pilot insertion module, most of this module is based upon understanding and leveraging a library. To map to the CUDA platform, the input is an array of cufftComplex symbols in global memory. It is shared among all the thread. Its length is an integer multiple of 64. The output is stored back into the input array. The array size is the same as the input. The time domain symbol representation is also cufftComplex. This approach enables to reduce the memory usage in global memory. For an algorithm, the CUDA CUFFT library has been used, essentially providing a black-box algorithm based on divide and conquer (likely based on the radix-2 Cooley-Turkey algorithm). As the implementation is optimized for the platform, the performance obtained is satisfactory. The whole stream of constellation symbols is fed into the algorithm at once. The algorithm does something called batching, which comprises calculating multiple IFFTs in parallel. It means that all the OFDM symbols, each a 64-point IFFT, are processed simultaneously, by distributing the IFFTs among the multiprocessors.

There is a mismatch in OFDM equations versus CUDA, e.g., OFDM equations need to be converted from continuous time to discrete time; the _F disappears. There is a time-shift in OFDM, however the CUFFT library does not provide such a parameter, whereby the input needs to be adapted accordingly (pilot insertion). For the correct output, note that the CUDA IFFT is not normalized; indeed, the factor 1/N has been omitted in the IFFT implementation. Note that it might be due to the fact that the FFT (unlike IFFT) does not require this normalization factor and that the algorithm has been designed for both ways. For performance reasons, the normalization factor part has been included in the signal shaping kernel.

Using the CUFFT library requires calling an independent kernel. The IFFT cannot be called from within a kernel, but is instead launched from the CPU. This involves inherently a high overhead; in the future, an 802.11a transmitter may be merged into a single kernel, without reliance on the CUFFT library.

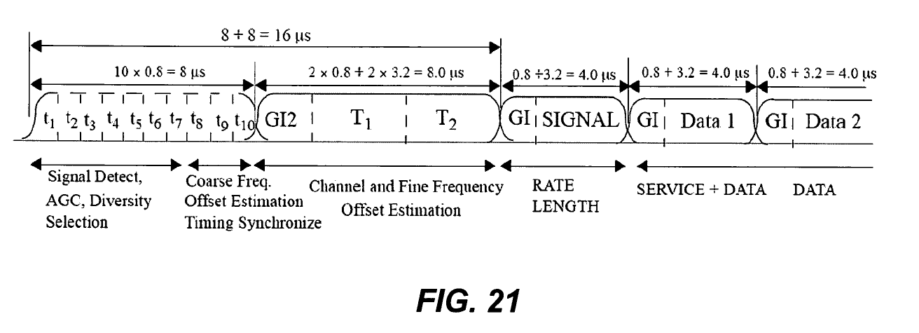

Turning to signal shaping and FIG. 21, signal shaping includes in two aspects, namely cyclic prefix and windowing. In an OFDM symbol the cyclic prefix is a repetition of the end of the symbol at the beginning. The purpose is to allow multipath to settle before the main data arrives at the receiver. The receiver is normally arranged to decode the signal after it has settled because this is when the frequencies become orthogonal to one another. The length of the cyclic prefix is equal to the guard interval (GI). More formally, cyclic prefix are often used in conjunction with modulation in order to retain sinusoids' properties in multipath channels. It is well known that sinusoidal signals are eigenfunctions of linear, and time-invariant systems (LTI). Therefore, if the channel is assumed to be linear and time-invariant, then a sinusoid of infinite duration would be an eigenfunction. However, in practice, this cannot be achieved, as real signals are time-limited. So, to mimic the infinite behavior, prefixing the end of the symbol to the beginning makes the linear convolution of the channel appear as though it were a circular convolution, and thus, preserve the eigenfunction property in the part of the symbol after the cyclic prefix. In practice, the cyclic prefix copies the last 16 samples of each OFDM symbol at the beginning of the OFDM symbol, e.g., a 64-sample OFDM-symbol becomes to a 80-sample OFDM symbol.

The objective of windowing in the time domain is to smooth the transition between neighboring OFDM symbols (As generally represented in FIG. 21). Indeed the transition might cause a strong amplitude shift. This would result in strong side-lobes of the transmitted waveform that might interfere with neighboring frequency bands. The specifications of a window are not described in the 802.11a standard. The two only normative constraints are a given power spectral density mask and the modulation accuracy (which is dealt with in the analog part of the transmitter). So, the simplest window might be sufficient. The windowing can affect the power spectral density of the signal.

Because the side-lobes and the power spectrum density are only measurable after transmission through an RF transceiver, it is not possible at the present time to make sure which window will be suitable for the system. This motivates a rather flexible algorithm that can adapt the window size for future test cases. The window function chosen is the following:

$${w}_{T} ( t ) = \{ \begin{matrix}{sin}^{2} ( \frac{π}{2} ( 0.5 + t / {T}_{TR} ) ) & - {T}_{TR} / 2 < t < {T}_{TR} / 2 \\ 1 & {T}_{TR} / 2 \leq t \leq T - {T}_{TR} / 2 \\ {sin}^{2} ( \frac{π}{2} ( 0.5 - ( t - T ) / {T}_{TR} ) ) & T - {T}_{TR} / 2 \leq t < T + {T}_{TR} / 2\end{matrix}$$

where TTR is the transition period, or overlapping period between two contiguous OFDM symbols, T the duration of one OFDM symbol.

The input is an array of the samples of the OFDM symbols. The length is a multiple of 64. The windowing array is an array of floats of different lengths, depending on the windowing size. The output is an array of samples of OFDM symbols. The length is a multiple of 80.

The parallelism granularity is an OFDM sample. Each thread will read its corresponding input sample. The missing normalization factor from the IFFT is applied to the sample. For the windowing part, different transition periods TTR are offered: 0 ns, 50 ns, . . . , 400 ns which correspond to 0 to 9 overlapping samples in discrete time. For each sample that requires a windowing, the windowing coefficients are applied. Then the result is saved to the output array.

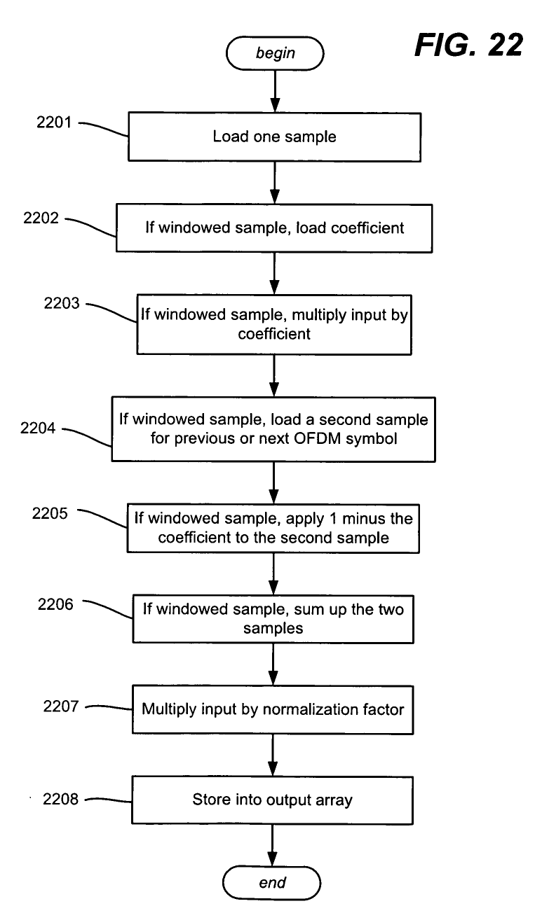

A high-level description for a thread tx is presented in the flow diagram of FIG. 22 as set forth below and in the form of pseudo code provided in algorithm box 6.
Step 2201: Load one sample
Step 2202: If windowed sample, load coefficient
Step 2203: If windowed sample, multiply input by coefficient
Step 2204: If windowed sample, load a second sample for previous or next OFDM symbol
Step 2205: If windowed sample, apply 1 minus the coefficient to the second sample
Step 2206: If windowed sample, sum up the two samples
Step 2207: Multiply input by normalization factor
Step 2208: Store into output array

Algorithm 6 Signal Shaping for thread tx

```
Require: an array I of samples, an array of floats T
Ensure: an array O of samples
  1: sample = I[f(tx)]
  2: if windowed sample then
  3:  sample2 = I[f(tx)]
  4:  coeff = T[tx]
  5:  sample = sample*coeff + sample2*(1−coeff)
  6: end if
  7: sample = sample*NORM_FACTOR
  8: O[tx] = sample
```

One thread block takes care of one OFDM symbol. Each thread is assigned to a sample within that OFDM symbol, so the algorithm requires 80 threads per block, which is two WARPs and one half-WARP. 16 threads take care of the cyclic prefix and 64 take of care of actual data symbol. Moreover some threads need to apply windowing. There is significant branching.

The input is an array of cufftComplex stored in global memory. The length is a multiple of 64. The windowing table is pre-calculated off-line in CPU from equation 4.9.1 and stored into host memory. Then the array corresponding to the windowing size chosen is transferred to constant memory. It is an array of floats. The output is an array of cufftComplex stored in global memory. The length is a multiple of 80.
1. Thread tx<16 (tx>16) will read input sample bx*64+48+tx (bx*64−16+tx) from global memory.
2. If windowing, then the thread loads a coefficient from constant memory.
3. If windowing, the input sample is multiplied by the coefficient.
4. If windowing, another sample from the previous (or next) OFDM symbol is also loaded.
5. If windowing, the second sample is multiplied by 1 minus the windowing coefficient.
6. If windowing, the two windowed samples are added together.
7. Then the thread multiplies the sample with the normalization factor (1/64) stored in a register.
8. The output is stored in global memory at position bx*80+tx.

The windowing module is merged with the cyclic prefix module to avoid copying the data back to global memory unnecessarily, because it is relatively expensive. In future versions, if a customized IFFT is being implemented, normalizing and windowing can be achieved right after the IFFT when data is still present in shared memory or in registers.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising, implementing a software defined radio platform, including processing an incoming bitstream in a graphics processing unit into baseband signals output from the graphics processing unit to radio frequency hardware.

2. The method of claim 1 further comprising, receiving the bitstream from a central processing unit via a in a MAC frame.

3. The method of claim 1 wherein processing the incoming bitstream into the baseband signals comprises merging at least some processing modules into a single GPU kernel.

4. The method of claim 1 wherein processing the incoming bitstream into the baseband signals comprises scrambling data corresponding to the input bitstream.

5. The method of claim 1 wherein processing the incoming bitstream into the baseband signals comprises encoding data corresponding to the input bitstream with error correction data.

6. The method of claim 1 wherein processing the incoming bitstream into the baseband signals comprises puncturing data corresponding to the input bitstream to adapt a coding rate.

7. The method of claim 1 wherein processing the incoming bitstream into the baseband signals comprises interleaving data corresponding to the input bitstream to redistribute contiguous coded bits in the data into interleaved data.

8. The method of claim 7 wherein the interleaved data comprises two sets of data, and wherein processing the incoming bitstream into the baseband signals comprises mapping the two sets of data into a single set of data.

9. The method of claim 8 wherein mapping the two sets of data into a single set of data comprises accessing a lookup table.

10. The method of claim 1 wherein processing the incoming bitstream into the baseband signals comprises adding pilot data to data corresponding to the bitstream.

11. The method of claim 1 wherein processing the incoming bitstream into the baseband signals comprises adding cyclic prefix data to data corresponding to the bitstream.

12. The method of claim 1 wherein processing the incoming bitstream into the baseband signals comprises applying a windowing function to modify data corresponding to the bitstream.

13. In a computing environment, a system comprising, a radio frequency transmitter, and a software-defined radio platform coupled to the transceiver, including a graphics processing unit that receives an outgoing bitstream to transmit from a central processing unit and converts the outgoing bitstream to an outgoing baseband signal for transmission by the transmitter.

14. The system of claim 13 wherein the graphics processing unit converts the outgoing bitstream to the outgoing baseband signal by executing kernels, including kernels corresponding to one or more modules, the modules including a physical layer convergence procedure module, scrambler module, encoder module, puncturer module, interleaver module, mapper module, pilot insertion module, OFDM module, cyclic prefix module, or windowing module, or any combination of a physical layer convergence procedure module, scrambler module, encoder module, puncturer module, interleaver module, mapper module, pilot insertion module, OFDM module, cyclic prefix module, or windowing module.

15. The system of claim 14 wherein at least two of the modules are merged into one of the kernels.

16. The system of claim 13 wherein the transmitter comprises an IEEE 802.11-based transmitter.

17. The system of claim 13 wherein the transmitter is incorporated into a radio frequency transceiver, and wherein the graphics processing unit receives an incoming baseband signal from the transceiver, converts the incoming baseband signal to an incoming bitstream, and provides the incoming bitstream to the central processing unit.

18. The system of claim 13 wherein the graphics processing unit converts the incoming baseband signal to the incoming bitstream by executing kernels, including kernels corresponding to one or more modules, the modules including a timing detection module, scrambler module, cyclic prefix removal module, a Fourier transform module, an equalizer module, a pilot correction module, a demapper module, a deinterleaver module, a depuncturer module, a decoder module, or a descrambler module, or any combination of a timing detection module, scrambler module, cyclic prefix removal module, a Fourier transform module, an equalizer module, a pilot correction module, a demapper module, a deinterleaver module, a depuncturer module, a decoder module, or a descrambler module.

19. One or more computer-readable media having computer-executable instructions, which when executed perform steps, comprising, executing graphics processing unit kernels to convert a first bitstream into a first baseband signal for transmission, and convert a second, received baseband signal into a second bitstream.

20. The one or more computer-readable media if claim 19 having further computer-executable instructions comprising, pre-calculating conversion data and maintaining the conversion data in one or more lookup tables, and wherein executing the kernels to convert the first bitstream into the first baseband signal comprises accessing the one or more lookup tables.
